(19) United States
(12) Patent Application Publication
(10) Pub. No.: US 2023/0385740 A1
(43) Pub. Date: Nov. 30, 2023

(54) Meeting Analysis and Coaching System

(71) Applicant: MICROSOFT TECHNOLOGY LICENSING, LLC, Redmond, WA (US)

(72) Inventors: Jan-Ove Karlberg, Tromsø (NO); Torbjørn Helvik, Oslo (NO); Jon Meling, Tromsø (NO)

(21) Appl. No.: 17/804,459

(22) Filed: May 27, 2022

(51) Int. Cl. G06Q 10/06

(52) U.S. Cl. CPC G06Q 10/0639

(57) ABSTRACT

Examples of the present disclosure describe systems and methods for meeting analysis and coaching. In examples, a meeting is monitored to identify meeting content associated with the meeting. The meeting content is analyzed to determine participant content for the participants of the meeting. A knowledge level for topics discussed in the meeting is determined for each participant. A set of policies for the meeting is evaluated to determine whether the set of policies has been satisfied. A set of info including the participant content, the knowledge levels for the participants, the evaluation of the set of policies, and other information is evaluated to generate insights for the participants of the meeting. The insights are provided to the participants of the meeting.

### BACKGROUND

Meetings are key interactions in any group or organization. For a meeting to be as valuable as possible for the participants, it is important that each participant is able to contribute to the meeting and efficiently learn from the other participants. However, these objectives can be difficult to achieve, especially within environments in which many meetings are conducted online due to geographically dispersed participants and other factors.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and methods for meeting analysis and coaching. In examples, a meeting is monitored to identify meeting content associated with the meeting. The meeting content is analyzed to determine participant content for the participants of the meeting. A knowledge level for topics discussed in the meeting is determined for each participant. A set of policies for the meeting is evaluated to determine whether the set of policies has been satisfied. A set of info including the participant content, the knowledge levels for the participants, the evaluation of the set of policies, and other information is evaluated to generate insights for the participants of the meeting. The insights are provided to the participants of the meeting.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Examples are described with reference to the following figures.

FIG. 1 illustrates an overview of an example system for meeting analysis and coaching.

FIG. 2 illustrates an example meeting insights system for meeting analysis and coaching.

FIG. 3 illustrates an example method for meeting analysis and coaching.

FIG. 4 is a block diagram illustrating example physical components of a computing device for practicing aspects of the disclosure.

FIGS. 5A and 5B are simplified block diagrams of an example mobile computing device for practicing aspects of the present disclosure.

FIG. 6 is a simplified block diagram of an example distributed computing system for practicing aspects of the present disclosure.

FIG. 7 illustrates an example tablet computing device for executing one or more aspects of the present disclosure.

### DETAILED DESCRIPTION

Meetings are an important and pervasive part of organizations, companies, departments, groups, and other assemblages of individuals (collectively referred to herein as “organizations”). To maximize the benefit of a meeting to the meeting participants, it is important that each participant is provided an opportunity to meaningfully contribute to the meeting. It is equally important that each participant is provided an opportunity to efficaciously glean pertinent information from the meeting. However, achieving these objectives can be difficult due to factors such as participant character traits (e.g., tendency towards introversion or extroversion, speaking volume, comfort with the language used in the meeting, tendency to deviate from a topic), actual and perceived disparities in participant knowledge levels or importance within the organization, difficulty of the topics discussed during the meeting, etc. Achieving these objectives can also be difficult due to the ever-increasing trend towards conducting online meetings and hybrid meetings (e.g., meeting that are partially in-person and partially online), which often present challenges such as technology issues (e.g., network latency resulting in meeting lag, microphone or speakers not working, camera or display issues), suboptimal working environments (e.g., participants are distracted or do not have access to necessary materials), and so on.

Many organizations are attempting to address the above objectives by working to establish key principles for effectively conducting meetings, such as ensuring that each meeting promotes allyship, open-mindedness, curiosity, and inclusiveness. However, evaluating the effectiveness of implementing these key principles is largely a manual, subjective process that is not metrics-driven. As a result, these key principles are implemented inadequately, if at all, and the organizations continue to receive suboptimal benefits from their meetings.

In light of the challenges with implementing and subsequently evaluating key principles for meetings, embodiments of the present disclosure provide systems and methods for meeting analysis and coaching. In examples, a meeting of an organization is monitored using an automated monitoring utility that identifies meeting content associated with the meeting. Examples of meeting content includes participant speech and video data, audio data (e.g., music, sound effects, background noises), meeting attachments, and content items presented during the meeting (e.g., documents, slide shows, video playback). The monitoring utility analyzes the meeting content to determine participant content for the participants of the meeting. The analysis of the meeting content may include speaker diarization, topic identification, sentiment analysis, transcription, translation, and other content analysis techniques. Speaker diarization, as used herein, refers to partitioning an audio signal into segments according to speaker identity. Examples of participant content includes information relating to the identification of a participant, the topic(s) discussed by a participant, the amount of time a participant was speaking or was speaking about each topic, the type of feedback a participant provides (e.g., verbal response, non-verbal response, non-response) for each speaker and/or topic, the sentiment of feedback or a response provided by a participant (e.g., assent, dissent, confusion, apathy) for each speaker and/or topic, and the like.

An automated assessment utility evaluates the participant content to determine a knowledge level of each participant with each topic discussed in the meeting. To determine a participant's knowledge level with a topic, the participant's user activity for a data domain is monitored over time. A data domain, as used herein, refers to a logical grouping of information relating to a common topic, purpose, or theme. As a specific example, a data domain for an organization includes the content items (e.g., documents, web pages, user communications, videos, images, audio, gestures) created or controlled by the organization and the organizational knowledge of the members of the organization. A data domain may comprise subdomains or be comprised by a super-domain. Examples of user activity include creating content items, modifying content items, accessing or viewing content items, sending content items, receiving content items, navigating content items (e.g., scrolling, clicking, panning, zooming), and commenting on content items. Monitoring the user activity includes applying event detection techniques to services and/or applications associated with a data domain.

The content items associated with the participant's user activity are evaluated to determine the topics associated with the content items. Evaluating the content items may comprise using machine learning (ML) and/or other automated techniques to scan the content items and/or metadata of the content items for topics of the content items, and assigning the topics to one or more portions (e.g., words, sentences, sections, pages) of the content items. A topic, as used herein, refers to a phrase or term that is significant or important to an organization. The content items and/or topics associated with a data domain may be stored in one or more data repositories, such as an enterprise knowledge graph, a graph database, or another type of data store. In alternative examples, instead of determining the topics associated with the content items, an existing taxonomy for the data domain is used. In such examples, the taxonomy comprises a collection of topics associated with content items of the data domain. Each of the topics in the taxonomy are identified by a unique identifier. In at least one example, the taxonomy also comprises associations between topics and the content items in which the topics were found. For instance, the taxonomy may comprise mappings that correlate each topic in the taxonomy to each content item in which the topic was found or referenced.

A participant's knowledge level with a topic is determined based on an evaluation of one or more factors, such as the amount of communication the participant has engaged in regarding the topic, the number of other users with whom the participant has communicated about the topic, the amount of time over which communications about the topic have occurred, the recency of communications about the topic, the number of content items created by the participant that includes the topic, the type of the user activity (e.g., content item authoring, content item viewing, content item receiving), the amount of time the participant spent navigating the topic within the content item, the participant's educational details, etc. In examples, a participant's knowledge level for a topic is assigned a value based on the evaluation of the factors discussed above. The value may be a label (e.g., unfamiliar, beginner, intermediate, advanced, expert), a numerical value (e.g., a number, a percentage, a range of numbers), or an alternative type of designation.

In some examples, participant knowledge levels with topics are maintained in an index or a similar data structure for the data domain. An index, as used herein, refers to a data structure that facilitates the efficient lookup of data (e.g., terms, phrases, values, key-value pairs) stored by the data structure. In one example, the index includes tuples for multiple users in the data domain, where each tuple comprises a user, a topic, and the user's knowledge level of the topic. The index can be updated in real-time in response to the detection of user activity and/or at predefined time intervals (e.g., hourly, daily, weekly).

An automated policy evaluation utility evaluates a set of policies, rules, or guidelines (collectively referred to herein as “policies”) for the meeting to determine whether the set of policies has been satisfied. In examples, the set of policies is defined by the organization and is intended to provide guidelines and/or best practices for conducting meetings within the organization. Each policy in the set of policies is associated with a directive and criteria that is evaluated by the policy evaluation utility to determine whether the directive, and thus the policy, has been satisfied. The set of policies used to evaluate a meeting may be determined automatically based on various factors, such as meeting type (e.g., one-on-one meeting, one-to-many or broadcast meetings), number of meeting participants, meeting objective(s) or requirement(s), organization philosophy, meeting topic(s), participant role (e.g., manager, direct report, team member), etc. One or more of the factors may be prioritized or weighted more heavily to reflect a specific organizational objective. Alternatively, the set of policies used to evaluate a meeting may be determined manually by a meeting participant or another member of the organization, such as a policy compliance expert, a team or organization leader, or the like. In examples, the policy evaluation utility evaluates a set of policies for a meeting in real-time (e.g., as the meeting progresses) or after the meeting has concluded.

An automated analytics utility evaluates a set of evaluation information comprising the information determined by the monitoring utility, the assessment utility, and/or the policy evaluation utility to generate one or more insights for the participants of the meeting. The set of evaluation information may additionally or alternatively comprise supplemental information, such as content items associated with a participant's user activity, organizational objectives or philosophies, a participant's amount of time with the organization, a participant's years of professional experience, a participant's number of publications, a participant's number and/or type of awards, a participant's educational details, etc. In examples, an insight provides feedback or guidance relating to a participant's performance in a meeting. The feedback may include information in or relating to the set of evaluation information and/or recommendations for improving the participant's performance in a meeting. An insight may also provide feedback regarding whether a meeting objective was satisfied or guidance relating how to satisfy a meeting objective or to improve the effectiveness of a meeting. Insights may be provided to participants (or to other members of an organization) in real-time (e.g., as the meeting progresses) or after the meeting has concluded. Insights may also be provided for an individual meeting or for a series of meetings. For example, the analytics utility may track evaluation information for a participant over multiple meetings and provide insights on a participant's trends over time (e.g., improvements or continued weaknesses) for those meetings.

Thus, the present disclosure provides a plurality of technical benefits and improvements over previous meeting solutions. These technical benefits and improvements include: an automated meeting monitoring system that identifies and analyzes meeting content, an automated knowledge assessment system that determines meeting participant knowledge levels on various topics, an automated policy evaluation system that stores and evaluates organizational policies for conducting meetings, an automated analytics system for generating insights for meeting participants and meetings, and an insights delivery system for providing or displaying meeting insights to meeting participants, among other examples.

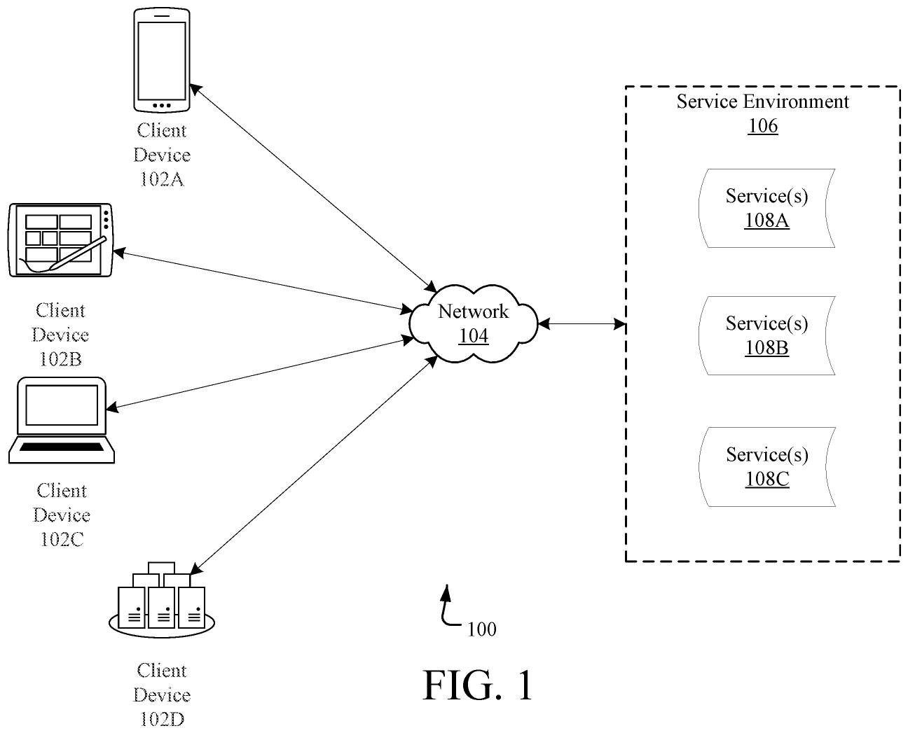

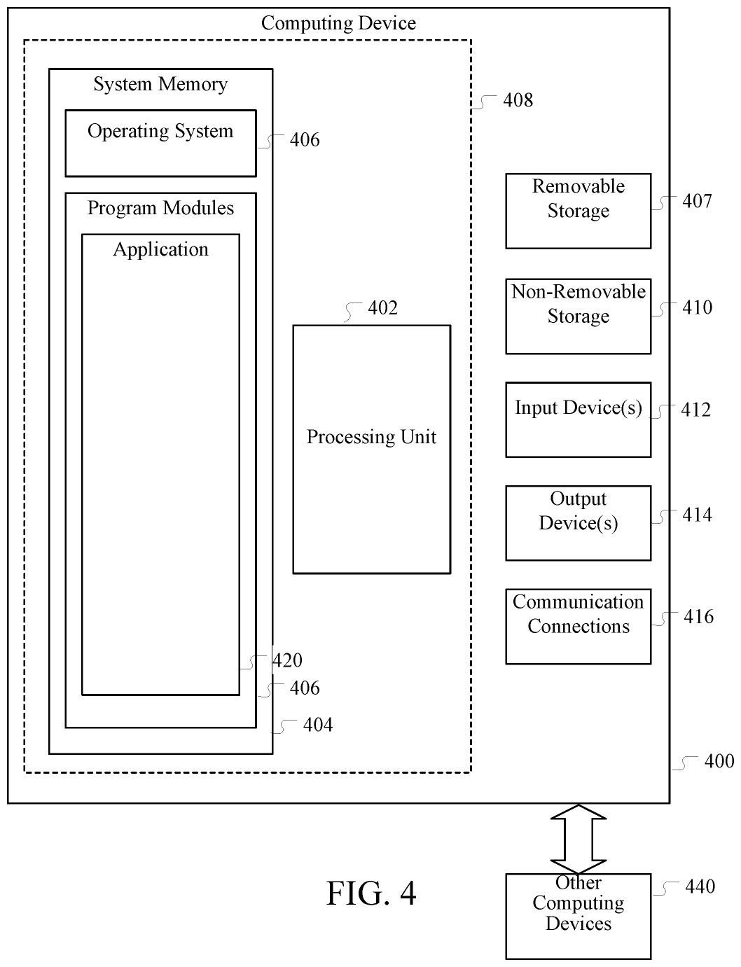

FIG. 1 illustrates an overview of an example system for meeting analysis and coaching. Example system 100 as presented is a combination of interdependent components that interact to form an integrated whole. Components of system 100 may be hardware components or software components (e.g., applications, application programming interfaces (APIs), modules, virtual machines, or runtime libraries) implemented on and/or executed by hardware components of system 100. In one example, components of systems disclosed herein are implemented on a single processing device. The processing device may provide an operating environment for software components to execute and utilize resources or facilities of such a system. An example of processing device(s) comprising such an operating environment is depicted in FIGS. 4-7. In another example, the components of systems disclosed herein are distributed across multiple processing devices. For instance, input may be entered on a user device or client device and information may be processed on or accessed from other devices in a network, such as one or more remote cloud devices or web server devices.

In FIG. 1, system 100 comprises client devices 102A, 102B, 102C, and 102D (collectively “client device(s) 102”), network 104, service environment 106, and service(s) 108A, 108B, and 108C (collectively “service(s) 108”). One of skill in the art will appreciate that the scale and structure of systems such as system 100 may vary and may include additional or fewer components than those described in FIG. 1. As one example, service environment 106 and/or one or more of service(s) 108 may be incorporated into client device(s) 102.

Client device(s) 102 may be configured to detect and/or collect input data from one or more users or user devices. In some examples, the input data corresponds to user interaction with one or more software applications or services implemented by, or accessible to, client device(s) 102. In other examples, the input data corresponds to automated interaction with the software applications or services, such as the automatic (e.g., non-manual) execution of scripts or sets of commands at scheduled times or in response to predetermined events. The user interaction or automated interaction may be related to the performance of user activity corresponding to a task, a project, a data request, or the like. The input data may include, for example, audio input, touch input, text-based input, gesture input, and/or image input. The input data may be detected/collected using one or more sensor components of client device(s) 102. Examples of sensors include microphones, touch-based sensors, geolocation sensors, accelerometers, optical/magnetic sensors, gyroscopes, keyboards, and pointing/selection tools. Examples of client device(s) 102 include personal computers (PCs), mobile devices (e.g., smartphones, tablets, laptops, personal digital assistants (PDAs)), wearable devices (e.g., smart watches, smart eyewear, fitness trackers, smart clothing, body-mounted devices, head-mounted displays), and gaming consoles or devices, and Internet of Things (IoT) devices.

Client device(s) 102 may provide the input data to service environment 106. In some examples, the input data is provided to service environment 106 using network 104. Examples of network 104 include a private area network (PAN), a local area network (LAN), a wide area network (WAN), and the like. Although network 104 is depicted as a single network, it is contemplated that network 104 may represent several networks of similar or varying types. In some examples, the input data is provided to service environment 106 without using network 104.

Service environment 106 is configured to provide client device(s) 102 access to various computing services and resources (e.g., applications, devices, storage, processing power, networking, analytics, intelligence). Service environment 106 may be implemented in a cloud-based or server-based environment using one or more computing devices, such as server devices (e.g., web servers, file servers, application servers, database servers), edge computing devices (e.g., routers, switches, firewalls, multiplexers), personal computers (PCs), virtual devices, and mobile devices. Alternatively, the service environment 106 may be implemented in an on-premises environment (e.g., a home or an office) using such computing devices. The computing devices may comprise one or more sensor components, as discussed with respect to client device(s) 102. Service environment 106 may comprise numerous hardware and/or software components and may be subject to one or more distributed computing models/services (e.g., Infrastructure as a Service (IaaS), Platform as a Service (PaaS), Software as a Service (SaaS), Functions as a Service (FaaS)). In aspects, service environment 106 comprises or provides access to service(s) 108.

Service(s) 108 may be integrated into (e.g., hosted by or installed in) service environment 106. Alternatively, one or more of service(s) 108 may be implemented externally to service environment 106. For instance, one or more of service(s) 108 may be implemented in a service environment separate from service environment 106 or in client device(s) 102. Service(s) 106 may provide access to a set of software and/or hardware functionality. Examples of service(s) 106 include virtual meeting services, topic detection and/or classification services, data domain taxonomy services, expertise assessment services, content detection services, audio signal processing services, word processing services, spreadsheet services, presentation services, document-reader services, social media software or platforms, search engine services, media software or platforms, multimedia player services, content design software or tools, database software or tools, provisioning services, and alert or notification services.

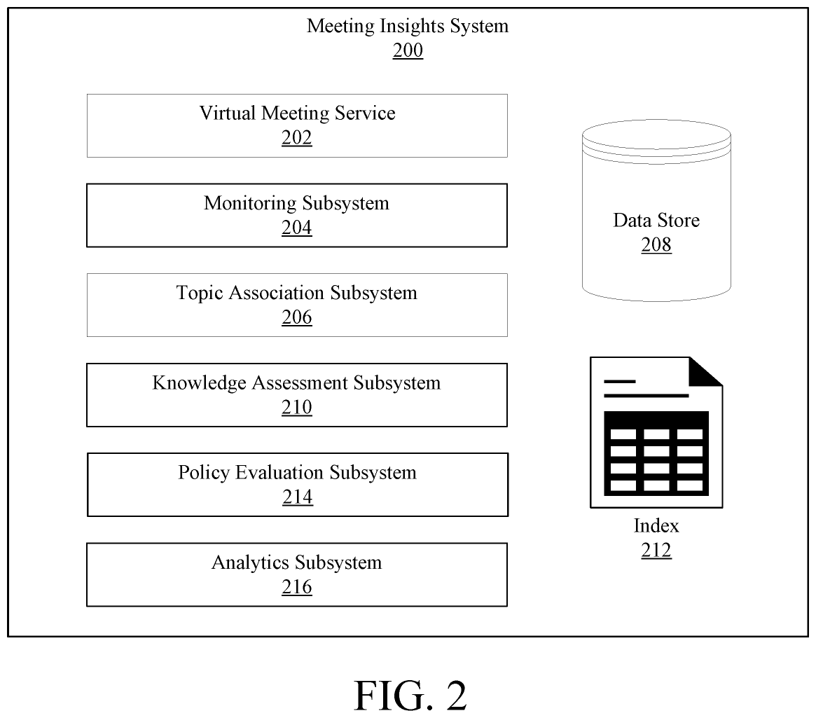

FIG. 2 illustrates an example meeting insights system for meeting analysis and coaching. The techniques implemented by meeting insights system 200 may comprise the techniques and data described in system 100 of FIG. 1. Although examples in FIG. 2 and subsequent figures will be discussed in the context of electronic meetings, the examples are equally applicable to other contexts, such as electronic communications (e.g., email, chat, text messages), voice calls, speech or presentation training, and the like. In some examples, one or more components described in FIG. 2 (or the functionality thereof) are distributed across multiple devices or computing systems in one or more computing environments. In other examples, a single device comprises the components described in FIG. 2.

In FIG. 2, meeting insights system 200 comprises virtual meeting service 202, monitoring subsystem 204, topic association subsystem 206, data store 208, knowledge assessment subsystem 210, index 212, policy evaluation subsystem 214, and analytics subsystem 216. It is to be appreciated that the scale of meeting insights system 200 may vary and may include additional or fewer components than those described in FIG. 2. As one example, index 212 may be integrated into data store 208. As another example, monitoring subsystem 204, knowledge assessment subsystem 210, policy evaluation subsystem 214, and analytics subsystem 216 may be incorporated into virtual meeting service 202 or into a component, such as a web browser, associated with meeting insights system 200. As yet another example, data store 208, index 212, and virtual meeting service 202 may be located externally to meeting insights system 200.

Virtual meeting service 202 is configured to enable one or more users to be participants in an electronic meeting, such as an online meeting, a hybrid meeting, or any another type of virtual meeting (collectively referred to herein as a “meeting”). In examples, virtual meeting service 202 may be implemented for a data domain such that the members of one or more organizations associated with the data domain may securely communicate with each other. In addition to facilitating meetings, virtual meeting service 202 may provide additional functionality, such as messaging (e.g., sending and receiving email, chat, text messages), file storage, and other application or service integration.

Monitoring subsystem 204 is configured to monitor meeting content provided in or associated with a meeting facilitated by virtual meeting service 202. In examples, monitoring subsystem 204 records or otherwise collects data provided by or associated with each meeting participant, such as audio data, video data, meeting attachments, and the like. Monitoring subsystem 204 analyzes the content for each meeting participant (“participant content”) using one or more content analysis techniques, such as speech-to-text, speaker diarization, sentiment analysis, speech translation, and acoustic event detection. For example, speaker diarization may be used to separate an audio data stream into multiple segments that each correspond to the speech of a meeting participant during different (or overlapping) time spans of the audio data stream. Based on the analysis of the participant content, information relating to the meeting may be determined and/or recorded, such as the topic(s) discussed by each meeting participant, the amount of time each topic was discussed by each meeting participant, the type and/or sentiment of feedback provided by each meeting participant for each topic, etc. In examples, monitoring subsystem 204 comprises or has access to topic association subsystem 206.

Topic association subsystem 206 is configured to determine topics associated with (e.g., explicitly indicated by or implicitly referenced by) participant content. Determining topics may comprise scanning text data, image data, audio data, video data, field identifiers, or metadata of the participant content. As one example, each sentence of a portion of participant content is evaluated to determine a common topic for the portion of participant content. As another example, a set of images in participant content is evaluated to determine a topic for each of the images or a common topic for the set of images. Topic association subsystem 206 associates the determined topics with the participant content by assigning, mapping, or otherwise correlating the determined topics to the participant content. For instance, topic association subsystem 206 may create a mapping index that maps each portion of participant content to a topic. In examples, topic association subsystem 206 stores the determined associations between the participant content and the topics in one or more data stores, such as data store 208.

Data store 208 is configured to store content associated with a data domain. A data domain may encompass one or more organizations or one or more groups within the organization(s). In examples, content items that are associated with a data domain are created, used, and/or controlled by members of the organization(s) associated with the data domain. In some examples, content items stored in data store 208 are only accessible to members of the organization associated with the data domain. Data store 208 may store content in various data structures, such as a knowledge graph, a graph database, a relational database, or an ontology structure. Data store 208 may also store metadata associated with content items and/or data structures (e.g., creation date/time, modification date/time, file size).

Knowledge assessment subsystem 210 is configured to determine a knowledge level of each meeting participant with each topic discussed in the meeting. In examples, knowledge assessment subsystem 210 accesses content items in data store 208 and/or content items associated with the data domain associated with data store 208. The content items are evaluated to determine a knowledge level of a meeting participant with a topic. As one example, a knowledge level may be determined based on the amount of communication a meeting participant has engaged in regarding a topic. For instance, knowledge assessment subsystem 210 may evaluate meeting participant communications (e.g., email messages, chat messages, text messages, meeting documents and transcriptions, phone calls) from communication applications and services of the meeting participant's organization to determine the frequency that the meeting participant has communicated about the topic. Knowledge assessment subsystem 210 may also determine the duration of each communication, the amount of the communication that is focused on the topic, and other communication metrics. Knowledge assessment subsystem 210 may then determine a meeting participant's knowledge level with a topic based on the communication metrics (e.g., frequency, duration, focus) such that higher knowledge levels are determined for high levels of communication metrics (e.g., high frequency, high duration, high focus). In examples, the knowledge levels may be represented as text values (e.g., beginner, intermediate, expert), numerical values (e.g., 6 on a scale of 0-10), or another type of designation (e.g., a color, an image, a sound, haptic feedback). Knowledge assessment subsystem 210 assigns the meeting participant's determined knowledge level to the topic.

In some examples, knowledge assessment subsystem 210 is further configured to maintain an index 212 of knowledge levels for members in a data domain. Knowledge assessment subsystem 210 provides to index 212 information relating to topics, data domain member identity, and data domain member knowledge levels for the topics. Index 212 stores the provided information such that efficient lookup of the information can be performed. In a specific example, index 212 stores tuples comprising a user identifier (for a data domain member), a topic identifier, and user knowledge level of a topic. In some examples, knowledge assessment subsystem 210 updates index 212 each time user activity for the data domain is detected. In other examples, index 208 is updated according to predefined time intervals.

Policy evaluation subsystem 214 is configured to evaluate a set of policies for a meeting. In examples, an organization may define meetings policies based on attributes of a meeting, such as meeting type, meeting participant roles, meeting topics, etc. The meeting policies may be stored in a data structure (e.g., an index or a registry), which may be stored in data store 208 or in another storage location. Each policy may comprise a directive, such as ensuring all participants contribute to the meeting, ensuring subject matter experts are primary contributors to the meeting, maintaining focus on meeting topics, and using inclusive language, among other examples. Each policy may also comprise criteria for achieving the directive. As one example, criteria for achieving a policy ensuring that all participants contribute to the meeting may be that at least 80% of the meeting participants speak for at least 5% of the meeting. As another example, criteria for achieving a policy ensuring that focus is maintained on meeting topics may be that the meeting topics are discussed for at least 75% of the duration of the meeting.

In some examples, the set of policies used to evaluate a meeting may be determined automatically based on various factors, such as meeting type, number of meeting participants, meeting objective(s) or requirement(s), organization philosophy, meeting topic(s), participant roles, etc. One or more of the factors may be prioritized or weighted more heavily to reflect an increased importance of the factor relative to other factors. For instance, the meeting type factor may be assigned a higher priority than the number of meeting participants, which indicates that a set of policies for a particular meeting type is to be selected over a set of policies for a particular number of meeting participants. In other examples, the set of policies used to evaluate a meeting may be determined manually by a meeting participant or another member of the organization, such as a policy compliance expert, a team or organization leader, or the like. For instance, the meeting organizer may select a set of policies to be used to evaluate a meeting.

Policy evaluation subsystem 214 may evaluate a set of policies for a meeting in real-time (e.g., as the meeting progresses). For instance, a selected set of policies may be applied to a meeting as meeting content is received and/or participant content is identified, at predefined intervals (e.g., every five seconds or 1 minute), or in response to predefined events, such as changes in topic, durations of silence (e.g., long pauses in speech or sound), presentation of content items (e.g., activating a slide show, sharing a document, playing a video), etc. Alternatively, policy evaluation subsystem 214 may evaluate a set of policies for a meeting at some point after the meeting has concluded. For instance, a selected set of policies may be applied to a meeting when the last participant of the meeting exits the meeting or at a predefined time after the meeting (e.g., 15 minutes).

Analytics subsystem 216 is configured to evaluate a set of evaluation information to generate one or more insights for meeting participants. In examples, the set of evaluation information includes information determined by the monitoring subsystem 204, topic association subsystem 206, knowledge assessment subsystem 210, and/or policy evaluation subsystem 214. For example, the set of evaluation information may include the topics discussed in the meeting, the amount of time each meeting participant discussed each topic during the meeting, the meeting participant's knowledge levels on each topic discussed during the meeting, a set of policies for the meeting, and whether criteria for the set of policies was achieved. The set of evaluation information may additionally or alternatively comprise supplemental information or analytics subsystem 216 may access supplemental information after (or before) receiving the set of evaluation information. The supplemental information may include content items (e.g., content items associated with a meeting participant's user activity, content items that are attachments for the meeting, content items presented in the meeting), organizational objectives (e.g., objectives related to improving meeting effectiveness, organizational culture, situational leadership), meeting participant information (e.g., organizational role, time with the organization, years of professional experience, educational details, number of publications, number and/or type of awards), etc.

In examples, evaluating the set of evaluation information comprises applying decision logic (e.g., one or more rules or machine learning (ML) techniques) to the set of evaluation information. For example, an ML model may be provided as input the intended topic for a meeting, the amount of time each meeting participant discussed the topic, each meeting participant's knowledge level of the topic, and whether a policy for the meeting was achieved. Based on the input, the ML model may output insights for the meeting participants. Insights provide feedback or guidance relating to a meeting participant's performance in a meeting. The feedback may include information in or relating to the set of evaluation information and/or recommendations for improving the participant's performance in a meeting. For instance, the ML model may provide a first insight that indicates a first meeting participant spoke for too much of the meeting based on the first meeting participant's novice knowledge level on the intended topic for the meeting and a second insight that indicates a second meeting participant did not speak enough during the meeting based on the second meeting participant's expert knowledge level on the intended topic for the meeting.

Insights may also provide feedback or guidance relating to the meeting itself. The feedback may include information relating to whether meeting objectives have been satisfied, optimizing the list of meeting participants, meeting length or frequency, or the like. For instance, the ML model may provide an insight that a meeting participant seldom contributes to a meeting and, thus, the meeting participant should no longer be invited to the meeting. As another example, the ML model may provide an insight that a meeting should be reduced from two hours to one hour because meeting participants are deviating from the intended topic of the meeting with significantly increased frequency after the first hour of the meeting.

Analytics subsystem 216 may provide insights to meeting participants or other members of an organization in real-time (e.g., as the meeting progresses). For example, meeting participants may be provided insights at predefined time intervals of the meeting (e.g., every 5 minutes or at 10% increments of the scheduled meeting time). Alternatively, insights may be provided to meeting participants at some point after the meeting has concluded. An insight may be provided to each meeting participant, even if the insight does not have a recommendation for improving a meeting participant's performance in the meeting. For instance, while some meeting participants may receive recommendations for improving their performance (e.g., “You should speak more often” or “You are currently off-topic”), other meeting participants may receive congratulatory or performance-affirming comments (e.g., “You are doing great!” or “You are currently satisfying meeting objectives”). Alternatively, an insight may only be provided to a meeting participant if the meeting participant's performance warrants improvement.

In some examples, an insight is provided to a meeting participant such that only that meeting participant has access to the insight. In other examples, an insight may also be displayed to all meeting participants of the meeting or to a particular member of the organization (e.g., a meeting participant's manager, the meeting organizer, a policy compliance expert, a skill development coach). An insight may be provided based on a particular instance of a meeting or based on multiple instances of one or more meetings. For example, analytics subsystem 216 may track the performance of a meeting participant across all meeting attended by the meeting participant. The insight(s) provided for the meeting participant may include recommendations for particular meeting instances or for the meeting participant's trends over time. For instance, although an insight for a particular meeting instance may indicate that a meeting participant needs to speak more frequently, the insight for the meeting participant's meeting performance over a six month period of time may be congratulatory and indicate that the meeting participant has consistently improved their speaking frequency in meetings during that period of time.

Having described one or more systems that may be employed by the aspects disclosed herein, this disclosure will now describe one or more methods that may be performed by various aspects of the disclosure. In aspects, method 300 may be executed by a system, such as system 100 of FIG. 1. However, method 300 is not limited to such examples. In other aspects, method 300 is performed by a single device or component that integrates the functionality of the components of system 100. In at least one aspect, method 300 is performed by one or more components of a distributed network, such as a web service or a distributed network service (e.g. cloud service).

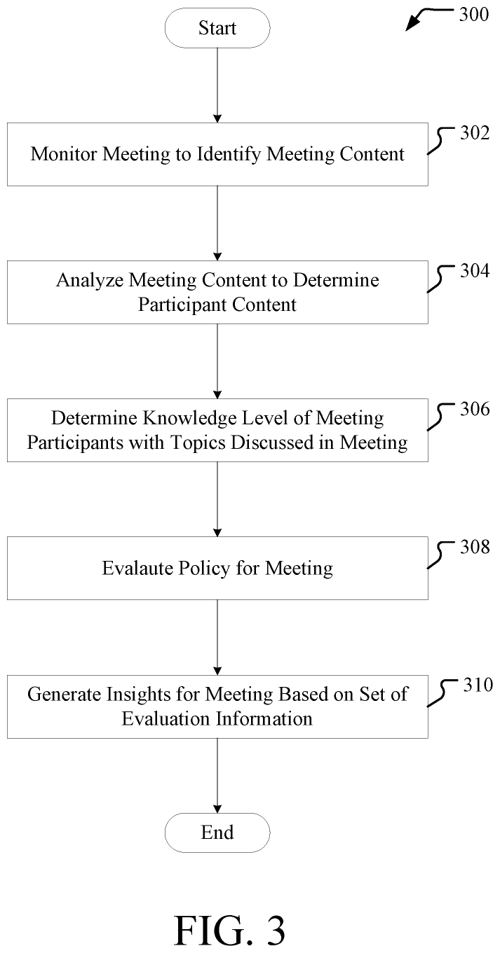

FIG. 3 illustrates an example method for meeting analysis and coaching. Example method 300 begins at operation 302, where a meeting is monitored to identify meeting content associated with the meeting. In examples, a monitoring component, such as monitoring subsystem 204, may be used to monitor a meeting facilitated by a meeting service, such as virtual meeting service 202. The monitoring component records or otherwise accesses meeting content, such as participant speech and video data, audio data (e.g., music, sound effects, background noises), meeting attachments, a meeting transcript, and content items presented by participants during the meeting. For example, the monitoring component may leverage a recording function of the meeting service to record the meeting. Alternatively, the monitoring component may incorporate recording functionality that is invoked when a meeting is initiated or in response to detected an event, such as manual selection of a button or control by a participant, detecting a keyword or key phrase spoken by a participant, detecting that all participants have joined the meeting, etc.

At operation 304, the meeting content is analyzed to determine participant content for the participants of the meeting. In examples, the monitoring component analyzes the meeting content using one or more content analysis techniques, such as speech-to-text, speaker diarization, topic identification, sentiment analysis, speech translation, and acoustic event detection. Based on the analysis, participant content for participants is identified. The participant content may include information relating to the identification of a participant, the topic(s) discussed by a participant, the amount of time a participant was speaking or was speaking about each topic, the type of feedback a participant provides for each speaker and/or topic, the sentiment of feedback or a response provided by a participant (e.g., assent, dissent, confusion, apathy) for each speaker and/or topic, and the like.

As a specific example, the speech in the audio and video data in the meeting content may be converted to text using a speech-to-text software of the monitoring component. A speaker diarization utility may be used to segment the converted text into text segments that are individually assigned to a respective participant. Each text segment may identify the participant and the time period of the meeting represented by the text segment. A sentiment analysis utility may be applied to the text segments to determine the respective participant's sentiment (e.g., positive, negative, assent, dissent, confusion, apathy) in their text segments. Indicators of a participant's sentiment for a text segment may be added to or otherwise associated with the text segment. For instance, a tag or other descriptor may be added to the text segment or to the metadata of the text segment. A topic determination component, such as topic association subsystem 206, is used to determine topics associated with the tagged (or untagged) text segments. The determined topics may be added to or otherwise associated with the text segment. For instance, a tag or other descriptor may be added to the text segment or the metadata of the text segment, or the determined topics (and information associated therewith) may be stored in a data structure, such as index 212.

At operation 306, knowledge levels for topics discussed in the meeting are determined for each participant. In aspects, a knowledge assessment component, such as knowledge assessment subsystem 210, accesses content items associated with the participants. For example, the knowledge assessment component may access a storage location, such as data store 208, that stores content items associated with a data domain of which the participants are members. The content items are evaluated to determine each participant's knowledge level with the topic(s) discussed in the meeting. The evaluation comprises analysis of one or more factors, such as the amount of communication the participant has engaged in regarding the topic, the number of other users with whom the participant has communicated about the topic, the amount of time over which communications about the topic have occurred, the recency of communications about the topic, the number of content items created by the participant that includes the topic, the type of the user activity (e.g., content item authoring, content item viewing, content item receiving), the amount of time the participant spent navigating the topic within the content item, the participant's educational details, etc. Alternatively, the knowledge assessment component may access a data structure that stores participant knowledge level information, such as index 212. In an example, the data structure stores participant knowledge level information as one or more data objects (e.g., an array, a hash, a tuple).

The knowledge assessment component assigns a value to a participant's knowledge level with a topic based on the evaluation of the factors discussed above. The value may be a label, a numerical value, or an alternative type of designation. For example, a set of rules for determining participant knowledge levels may dictate that a participant is assigned a knowledge level of “expert” for a topic when the participant has authored at least three documents on the topic in the last year, the participant has engaged in (sent or received) at least 25 communications regarding the topic in the last month, or the participant has an educational degree or certification on the topic or a knowledge area encompassing the topic. When a participant satisfies one or more of these criteria, the knowledge assessment component assigns the label “expert” to the participant's knowledge level with the topic. Alternatively, the knowledge assessment component assigns the participant's knowledge level for the topic an 8 on a scale from 0 to 10, where 0-3 indicates beginner knowledge, 4-7 indicate intermediate knowledge, and 8-10 indicates expert knowledge. In such an example, the label or the numerical value increases as the number of criteria satisfied increases, a value evaluated for a single criterion increases (e.g., three documents, 25 communications five certifications), or a frequency evaluated for a single criterion increases (e.g., one time per month versus ten times per month).

At operation 308, a set of policies for the meeting is evaluated. In examples, a set of policies is defined to provide guidelines and/or best practices for conducting meetings within the organization. The set of policies may provide differing guidance based on attributes of the meeting, such as meeting type, meeting participant roles, meeting topics, etc. As one example, a set of policies for a one-on-one meeting between a manager and a direct report may be configured to ensure that the manager is exhibiting situational leadership during the meeting, whereas a set of policies for a broadcast meeting (e.g., a one-to-many meeting) between an organizational leader and the organization's employees may be configured to ensure that the organizational leader is maintaining focus on a topic and is using inclusive language.

In some examples, a policy component, such as policy evaluation subsystem 214, determines the set of policies used to evaluate a meeting automatically based on various factors, such as meeting type, number of meeting participants, meeting objective(s) or requirement(s), organization philosophy, meeting topic(s), participant roles, etc. One or more of the factors may be prioritized or weighted more heavily to reflect an increased importance of the factor relative to other factors. As one example, multiple set of policies may be applicable to a meeting, such as a set of policies for the meeting type, a set of policies for the number of meeting participants, and a set of policies for the meeting topic(s). The sets of policies may be prioritized such that policies for the meeting type are prioritized as the highest priority, policies for the meeting topic(s) are prioritized as the next highest priority, and policies for the number of meeting participants are prioritized as the lowest priority. As such, the set of policies having the highest priority is used for evaluating the meeting. In at least one example, two or more of the applicable sets of policies for a meeting may be used to evaluate the meeting. For instance, each applicable set of policies may be used to evaluate the meeting such that conflicting policies are not enforced or only the policies of the set of policies having the higher priority are enforced. In other examples, the set of policies used to evaluate a meeting may be determined manually by a meeting participant or another member of the organization.

At operation 310, a set of evaluation information is evaluated to generate one or more insights for meeting participants. In examples, the set of evaluation information includes information determined by the monitoring component, topic determination component, the knowledge assessment component, and/or the policy evaluation component. The set of evaluation information may additionally or alternatively comprise supplemental information, such as content items, organizational objectives, meeting participant information, etc. As one example, a set of evaluation information may include the topics discussed in the meeting, each participant's sentiment on each topic, the amount of time each meeting participant discussed each topic during the meeting, the meeting participant's knowledge levels on each topic discussed during the meeting, a set of policies for the meeting, and each participant's organizational role.

In examples, an analytics component, such as analytics subsystem 216, applies decision logic to the set of evaluation information. Based on the decision logic, the analytics component provides insights to meeting participants and/or other members of the organization. For example, an ML model may evaluate the set of evaluation information to determine that a meeting primarily related to a single topic, a first participant having a “beginner” knowledge level of the topic discussed the topic for 60% of the meeting, a second participant was off-topic 80% of the time the second participant was speaking, and a third participant having an “expert” knowledge level of the topic discussed the topic for 5% of the meeting. Based on these determinations, the ML model or the analytics component provides the first participant the insight “Try to be more mindful of leveraging subject matter expertise. In the previous meeting, participant 3 was an expert on the topic but only spoke for 1 minute.” The second participant is provided the insight “Try to avoid the meeting getting off track. In the last meeting, you spent 45 minutes talking about an unrelated topic.” The third participant is provided the insight “You only spoke for 1 minute, despite having the highest level of knowledge with the topic of all the meeting participants.”

The analytics component may provide insights in real-time during the meeting and/or at some point after the meeting has concluded. For example, a participant may be provided insights during pre-defined intervals of the meeting. The insights may be provided in a notification section of a user interface for the meeting service or for the monitoring component. Alternatively, the insights may be provided as pop-ups, email messages, text messages, organization internal feeds, and the like. In some examples, the insights may be provides using audio-based feedback, haptic feedback, or any other type of feedback. After the conclusion of the meeting, the participant may be provided a report that includes each of the insights provide during the meeting and/or one or more insights for the entire meeting. In at least one example, the report also includes a historical report of insights for the participant in previous instances of the meeting. In another example, the report also includes a historical report of insights for the participants for all meetings attended by the participant.

FIGS. 4-7 and the associated descriptions provide a discussion of a variety of operating environments in which aspects of the disclosure may be practiced. However, the devices and systems illustrated and discussed with respect to FIGS. 4-7 are for purposes of example and illustration, and, as is understood, a vast number of computing device configurations may be utilized for practicing aspects of the disclosure, described herein.

FIG. 4 is a block diagram illustrating physical components (e.g., hardware) of a computing device 400 with which aspects of the disclosure may be practiced. The computing device components described below may be suitable for the computing devices and systems described above. In a basic configuration, the computing device 400 includes at least one processing unit 402 and a system memory 404. Depending on the configuration and type of computing device, the system memory 404 may comprise volatile storage (e.g., random access memory), non-volatile storage (e.g., read-only memory), flash memory, or any combination of such memories.

The system memory 404 includes an operating system 405 and one or more program modules 406 suitable for running software application 420, such as one or more components supported by the systems described herein. The operating system 405, for example, may be suitable for controlling the operation of the computing device 400.

Furthermore, embodiments of the disclosure may be practiced in conjunction with a graphics library, other operating systems, or any other application program and is not limited to any particular application or system. This basic configuration is illustrated in FIG. 4 by those components within a dashed line 408. The computing device 400 may have additional features or functionality. For example, the computing device 400 may include additional data storage devices (removable and/or non-removable) such as, for example, magnetic disks, optical disks, tape, and other computer readable media. Such additional storage is illustrated in FIG. 4 by a removable storage device 407 and a non-removable storage device 410.

The term computer readable media as used herein includes computer storage media. Computer storage media includes volatile and nonvolatile, removable and non-removable media implemented in any method or technology for storage of information, such as computer readable instructions, data structures, or program modules. The system memory 404, the removable storage device 407, and the non-removable storage device 410 are all computer storage media examples (e.g., memory storage). Computer storage media may include random access memory (RAM), read-only memory (ROM), electrically erasable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, RF, infrared, and other wireless media.

As stated above, a number of program modules and data files may be stored in the system memory 404. While executing on the processing unit 402, the program modules 406 (e.g., application 420) may perform processes including the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 400 on the single integrated circuit (chip). Embodiments of the disclosure may also be practiced using other technologies capable of performing logical operations such as, for example, AND, OR, and NOT, including mechanical, optical, fluidic, and quantum technologies. In addition, embodiments of the disclosure may be practiced within a general-purpose computer or in any other circuits or systems.

The computing device 400 may also have one or more input device(s) 412 such as a keyboard, a mouse, a pen, a sound or voice input device, a touch or swipe input device, etc. Output device(s) 414 such as a display, speakers, a printer, etc. may also be included. The aforementioned devices are examples and others may be used. The computing device 400 may include one or more communication connections 416 allowing communications with other computing devices 440. Examples of suitable communication connections 416 include radio frequency (RF) transmitter, receiver, and/or transceiver circuitry; universal serial bus (USB), parallel, and/or serial ports.

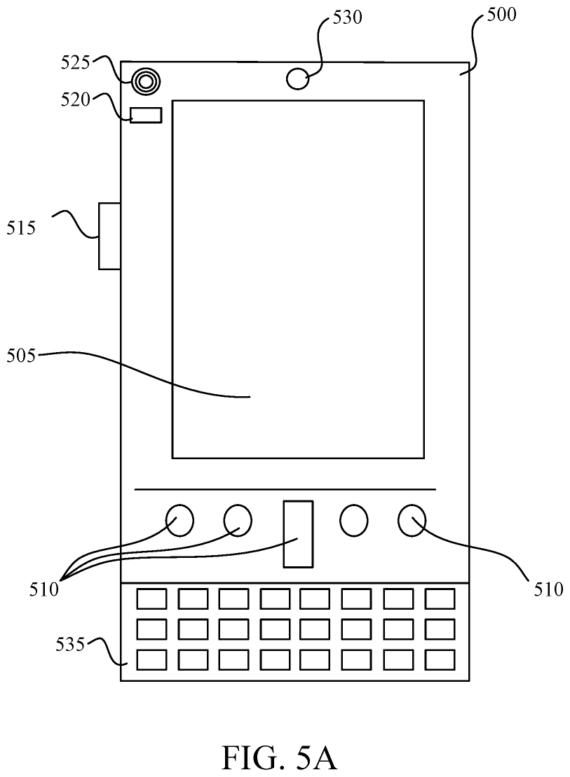

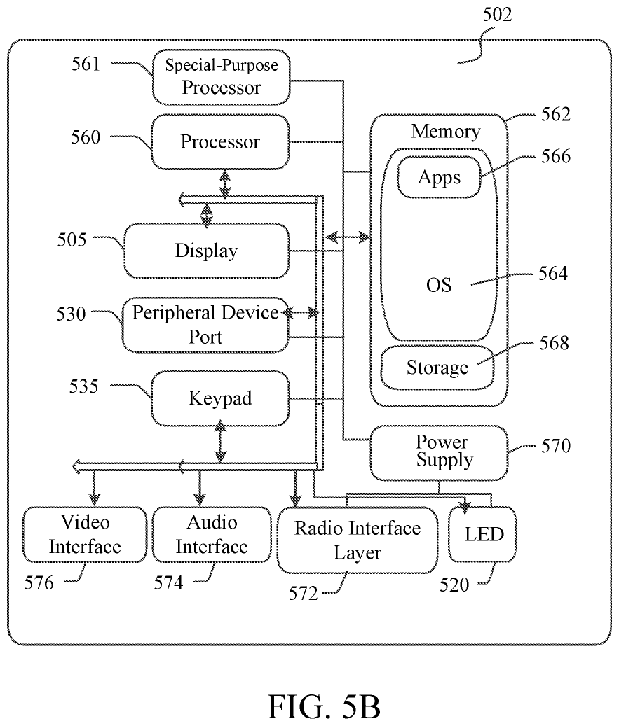

FIGS. 5A and 5B illustrate a mobile computing device 500, for example, a mobile telephone (e.g., a smart phone), wearable computer (such as a smart watch), a tablet computer, a laptop computer, and the like, with which embodiments of the disclosure may be practiced. In some aspects, the client device is a mobile computing device. With reference to FIG. 5A, one aspect of a mobile computing device 500 for implementing the aspects is illustrated. In a basic configuration, the mobile computing device 500 is a handheld computer having both input elements and output elements. The mobile computing device 500 typically includes a display 505 and may include one or more input buttons 510 that allow the user to enter information into the mobile computing device 500. The display 505 of the mobile computing device 500 may also function as an input device (e.g., a touch screen display).

If included, an optional side input element 515 allows further user input. The side input element 515 may be a rotary switch, a button, or any other type of manual input element. In alternative aspects, mobile computing device 500 incorporates more or less input elements. For example, the display 505 may not be a touch screen in some embodiments.

In yet another alternative embodiment, the mobile computing device 500 is a mobile telephone, such as a cellular phone. The mobile computing device 500 may also include an optional keypad 535. Optional keypad 535 may be a physical keypad or a “soft” keypad generated on the touch screen display.

In various embodiments, the output elements include the display 505 for showing a graphical user interface (GUI), a visual indicator 520 (e.g., a light emitting diode), and/or an audio transducer 525 (e.g., a speaker). In some aspects, the mobile computing device 500 incorporates a vibration transducer for providing the user with tactile feedback. In yet another aspect, the mobile computing device 500 incorporates input and/or output ports, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one aspect of a mobile computing device. That is, the mobile computing device can incorporate a system (e.g., an architecture) 502 to implement some aspects. In one embodiment, the system 502 is implemented as a “smart phone” capable of running one or more applications (e.g., browser, e-mail, calendaring, contact managers, messaging clients, games, and media clients/players). In some aspects, the system 502 is integrated as a computing device, such as an integrated personal digital assistant (PDA) and wireless phone.

One or more application programs 566 may be loaded into the memory 562 and run on or in association with the operating system (OS) 564. Examples of the application programs include phone dialer programs, e-mail programs, personal information management (PIM) programs, word processing programs, spreadsheet programs, Internet browser programs, messaging programs, and so forth. The system 502 also includes a non-volatile storage area 568 within the memory 562. The non-volatile storage area 568 may be used to store persistent information that should not be lost if the system 502 is powered down. The application programs 566 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device described herein (e.g., search engine, extractor module, relevancy ranking module, answer scoring module).

The system 502 has a power supply 570, which may be implemented as one or more batteries. The power supply 570 might further include an external power source, such as an AC adapter or a powered docking cradle that supplements or recharges the batteries.

The system 502 may also include a radio interface layer 572 that performs the function of transmitting and receiving radio frequency communications. The radio interface layer 572 facilitates wireless connectivity between the system 502 and the “outside world,” via a communications carrier or service provider. Transmissions to and from the radio interface layer 572 are conducted under control of the operating system 564. In other words, communications received by the radio interface layer 572 may be disseminated to the application programs 566 via the OS 564, and vice versa.

The visual indicator (e.g., light emitting diode (LED) 520) may be used to provide visual notifications, and/or an audio interface 574 may be used for producing audible notifications via the audio transducer 525. In the illustrated embodiment, the visual indicator 520 is a light emitting diode (LED) and the audio transducer 525 is a speaker. These devices may be directly coupled to the power supply 570 so that when activated, they remain on for a duration dictated by the notification mechanism even though the processor(s) (e.g., processor 560 and/or special-purpose processor 561) and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. In accordance with embodiments of the present disclosure, the microphone also serves as an audio sensor to facilitate control of notifications, as will be described below. The system 502 may further include a video interface 576 that enables an operation of a peripheral device port 530 (e.g., an on-board camera) to record still images, video stream, and the like.

A mobile computing device 500 implementing the system 502 may have additional features or functionality. For example, the mobile computing device 500 may also include additional data storage devices (removable and/or non-removable) such as, magnetic disks, optical disks, or tape. Such additional storage is illustrated in FIG. 5B by the non-volatile storage area 568.

Data/information generated or captured by the mobile computing device 500 and stored via the system 502 may be stored locally on the mobile computing device 500, as described above, or the data may be stored on any number of storage media that may be accessed by the device via the radio interface layer 572 or via a wired connection between the mobile computing device 500 and a separate computing device associated with the mobile computing device 500, for example, a server computer in a distributed computing network, such as the Internet. As should be appreciated such data/information may be accessed via the mobile computing device 500 via the radio interface layer 572 or via a distributed computing network. Similarly, such data may be readily transferred between computing devices for storage and use according to well-known data transfer and storage means, including electronic mail and collaboration data sharing systems.

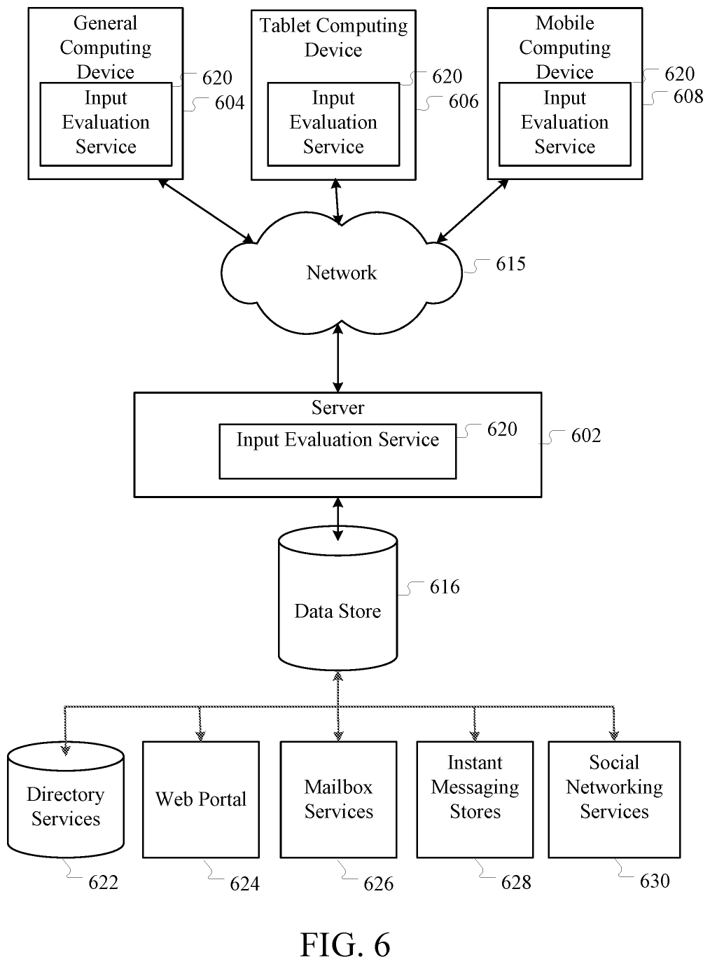

FIG. 6 illustrates one aspect of the architecture of a system for processing data received at a computing system from a remote source, such as a personal computer 604, tablet computing device 606, or mobile computing device 608, as described above. Content displayed at server device 602 may be stored in different communication channels or other storage types. For example, various documents may be stored using directory services 622, web portals 624, mailbox services 626, instant messaging stores 628, or social networking services 630.

An input evaluation service 620 may be employed by a client that communicates with server device 602, and/or input evaluation service 620 may be employed by server device 602. The server device 602 may provide data to and from a client computing device such as a personal computer 604, a tablet computing device 606 and/or a mobile computing device 608 (e.g., a smart phone) through a network 615. By way of example, the computer system described above may be embodied in a personal computer 604, a tablet computing device 606 and/or a mobile computing device 608 (e.g., a smart phone). Any of these embodiments of the computing devices may obtain content from the data store 616, in addition to receiving graphical data useable to be either pre-processed at a graphic-originating system, or post-processed at a receiving computing system.

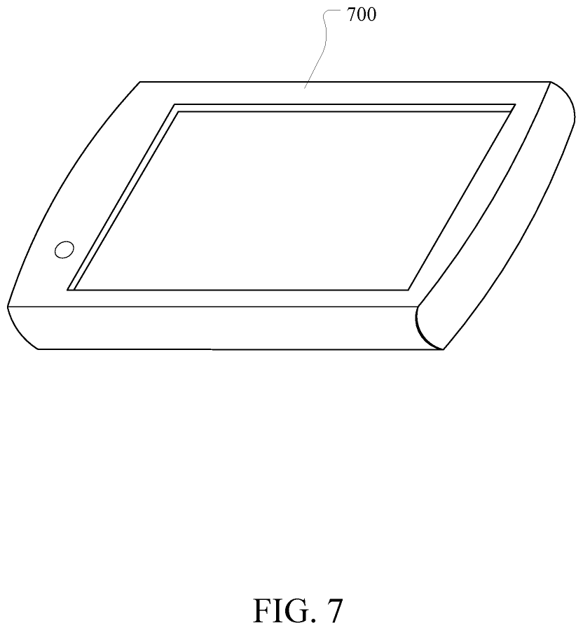

FIG. 7 illustrates an example of a tablet computing device 700 that may execute one or more aspects disclosed herein. In addition, the aspects and functionalities described herein may operate over distributed systems (e.g., cloud-based computing systems), where application functionality, memory, data storage and retrieval, and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
a processor; and
memory coupled to the processor, the memory comprising computer executable instructions that, when executed by the processor, perform a method comprising:
monitoring a meeting to identify meeting content associated with the meeting;
analyzing the meeting content to determine participant content for participants of the meeting, wherein the participant content includes one or more topics for the meeting;
determining a knowledge level of each of the participants with the one or more topics;
evaluating a policy for the meeting; and
generating one or more insights for the meeting based on a set of evaluation information, the set of evaluation information comprising at least the one or more topics for the meeting.

2. The system of claim 1, wherein the meeting content comprises at least one of:
speech data for the participants; or
video data for the participants.

3. The system of claim 2, wherein the meeting content further comprises at least one of:
content items that are attachments for the meeting;
a meeting transcript; or
content items presented during the meeting

4. The system of claim 1, wherein analyzing the meeting content comprises using a topic identification technique to determine the one or more topics in the meeting content.

5. The system of claim 4, wherein determining the one or more topics comprises scanning at least one of text data or video data of the participant content.

6. The system of claim 1, wherein analyzing the meeting content further comprises using at least one of speaker diarization or sentiment analysis.

7. The system of claim 6, wherein the speaker diarization segments the meeting content into text segments that are each assigned to a respective participant.

8. The system of claim 6, wherein the sentiment analysis determines a sentiment of the participants for the one or more topics.

9. The system of claim 1, wherein the participant content further comprises information relating to identification of the participants and at least one of:
an amount of time one or more of the participants was speaking during the meeting;
a type of feedback provided by one or more of the participants; or
a sentiment of feedback provided by one or more of the participants.

10. The system of claim 1, wherein determining the knowledge level of each of the participants comprises:
accesses one or more content items associated with each of the participants; and
evaluating the one or more content items to determine the knowledge level of each of the participants.

11. The system of claim 10, wherein evaluating the one or more content items comprises analyzing at least one of:
an amount of communication each of the participants has engaged in regarding the one or more topics;
a number of other users with whom each of the participants has communicated about the one or more topics; or
an amount of time over which each of the participants has communicated about the one or more topics.

12. The system of claim 10, wherein evaluating the one or more content items comprises analyzing at least one of:
a recency of communications by each of the participants about the one or more topics; or
a number of content items created by each of the participants that includes the one or more topics.

13. The system of claim 1, wherein the policy for the meeting provides guidelines or best practices for conducting meetings within an organization, the participants being members of the organization.

14. The system of claim 1, wherein evaluating the policy for the meeting comprises:
selecting the policy for the meeting from a set of policies based on attributes of the meeting, the attributes including at least one of:
a type of the meeting;
one or more roles of the participants; or
the one or more topics.

15. The system of claim 1, wherein the set of evaluation information further comprises:
the knowledge level of each of the participants with the one or more topics; and
the policy for the meeting.

16. The system of claim 1, wherein the one or more insights provide feedback of the performance of the one or more of the participants during the meeting.

17. A method comprising:
monitoring a meeting to identify meeting content associated with the meeting;
analyzing the meeting content to determine participant content for participants of the meeting, wherein the participant content includes one or more topics discussed by the participants during in the meeting;
determining a knowledge level of each of the participants with the one or more topics;
evaluating a policy for the meeting; and
generating one or more insights for the meeting based on a set of evaluation information, the set of evaluation information comprising at least the one or more topics for the meeting.

18. The method of claim 17, wherein the one or more insights provide recommendations for improving effectiveness of the meeting.

19. The method of claim 17, wherein the one or more insights are provided in real-time during the meeting.

20. A device comprising:
a processor; and
memory coupled to the processor, the memory comprising computer executable instructions that, when executed by the processor, perform a method comprising:
monitoring a meeting to identify meeting content associated with the meeting;
analyzing the meeting content to determine participant content for participants of the meeting, wherein the participant content includes one or more topics for the meeting;
determining a knowledge level of each of the participants with the one or more topics;
evaluating a policy for the meeting; and
generating one or more insights for the meeting based on a set of evaluation information, the set of evaluation information comprising at least the one or more topics for the meeting.
